(19) United States
(12) Patent Application Publication
(10) Pub. No.: US 2009/0285931 A1
(43) Pub. Date: Nov. 19, 2009

(54) Feed supplement for animals for reducing methane production

(76) Inventors: Nancy J. Shelby, Bozeman, MT (US); Mitchell T. Godfrey, Bozeman, MT (US)

Correspondence Address: PATE PIERCE & BAIRD, 175 SOUTH MAIN STREET, SUITE 1250, SALT LAKE CITY, UT, 84111, US

(21) Appl. No.: 12/322,593

(22) Filed: Feb. 4, 2009

Related U.S. Application Data
(60) Provisional application No. 61/063,645, filed on Feb. 4, 2008.

(51) Int. Cl. A23K 1/18; A23K 1/00; A23L 1/20; A47J 39/00

(52) U.S. Cl. 426/2; 426/635; 426/630; 426/465

(57) ABSTRACT

A method for enhancing feed efficiency and reducing enteric methane production in livestock, comprising a formulation of natural plants and plant extracts and chemicals, including propionatic acid glycerol, that when feed to ruminants results in decreased enteric methane production and improved feed efficiency.

### RELATED APPLICATIONS

This application claims the benefit of U.S. Provisional Patent Application Ser. No. 61/063,645, filed on Feb. 4, 2008 for FEED SUPPLEMENT FOR ANIMALS FOR REDUCING METHANE PRODUCTION, which is incorporated herein by reference.

### BACKGROUND

1. Field of the Invention

The present invention relates to the field of animal feed and nutrition, especially ruminants, and optimizing the feed of the animals to enhance health, growth, meat and milk production by maximizing nutrients, while decreasing enteric methane emission. A feed supplement consisting of natural substances selected and processed based on desired levels of chemicals that enhance feed efficiency while decreasing enteric methane emissions.

2. Background Art

Improvements in nutritionally and economically sound feeds for livestock continue to be needed and developed. Strategies for improving utilization of feed for the best health and weight gain rate while decreasing livestock methane emissions have renewed importance due to the realization of the impact of livestock enteric methane emissions on global warming (IPCC, 2001). Enteric methane emissions are a major source of greenhouse gas in agriculture, and are formed in the rumen through a process called enteric fermentation. During this normal digestive process, hydrogen is released by other microbes during fermentation of forage and is used by methanogenic archaea (i.e. methanogens) to reduce carbon dioxide to methane.

Methane has 23 times the potential for global warming compared with carbon dioxide. The contribution of methane by animals, primarily ruminants, is estimated at 40% of the atmospheric methane accumulation (Moss A. et al., 2000). For some nations, animal derived methane production represents greater than 40% of their carbon footprint. The methane produced from enteric fermentation by domesticated livestock is estimated to contribute >21% of US anthropogenic emissions of ‘greenhouse’ gas. In 2002, enteric fermentation from livestock accounted for 32% of all agricultural greenhouse gas emissions in Canada. Despite a 20% decline in the number of dairy cows from 199,000 in 1990 to 160,600 in 2000, enteric emissions in Canada have increased 11% since 1990, mainly due to increased beef production. Similar increases have been observed in the United States. Reducing enteric methane emissions has been identified as one way of lowering global methane emissions. Given the significant impact of livestock on greenhouse gas production, technologic strategies that reduce enteric and manure methane production are desirable (Ominski and Wittenberg, 2004).

Methane is produced as a bi-product of normal animal digestion, especially ruminal fermentation in cattle. Ruminant animals are the primary sources of enteric methane, possessing a rumen, or large “fore-stomach” in which microbial fermentation process the high fiber plant material in their diet. The rumen is filled with microorganisms, billions of bacteria, fungi and protozoa that break down food into nutrients via fermentative process. The microorganisms process the plant polysaccharides to acetic, propoionic and butyric acids, and the gases, methane (CH₄) and carbon dioxide (CO₂). Ruminants, including cattle, sheep and goats use acetate, propionate, butyrate and the microbial biomass as biosynthetic precursors and sources of energy and amino acids. Hydrogen is an intermediate in the anaerobic breakdown of organic matter in the rumen. It is produced by major fermentative and hydrolytic microorganisms, and then is reutilized by methanogenic archaea bacteria that use hydrogen (H₂) to reduced CO₂ to produce methane. Most of methanogens are associated with the protozoa that reside in the rumen. The majority of the methane is released by belching by the animal, thereby contributing to green house gas increases in the atmosphere (Johnson and Johnson, 1995).

Manipulation of enteric fermentation to reduce methane emissions may also increase nutrient utilization and feed efficiency by diverting the energy towards glucogenesis through the succinate/propionate pathways. Enteric methane may represent up to 13% or greater of the energy in animal feed and is associated with less efficiency and less weight gain. Decreasing methane production in ruminants has been associated with improved weight gain and feed efficiency. When methane formation is inhibited, fumarate becomes an alternative H2 sink, more propionate is produced, which provides energy to the animal since it is glucogenic (acetate and butyrate are not glucogenic). Thus, strategies that promote the propionate pathway in rumen fermentation will likely favor better livestock performance with the added benefit of methane emission reduction.

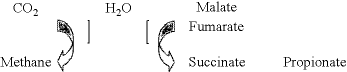

There have been several reports of efforts to decrease methane production and conserving energy for animal growth. In many studies it has been shown that low quality forage is associated with higher methane production, and the converse, higher quality forage, concentrates and supplements decrease methane production while enhancing the productivity of the animal, both in weight gain and in milk production measures. However, there is currently no commercially available product in the form of a supplement or concentrate that has been optimized specifically to address methane emission reduction while enhancing animal performance (Boadi et al., 2004).

Studies examining the methane emissions of cattle or sheep grazing on pasture or fed seasonal forage have shown that early spring time feedings are associated with less methane emissions as compared with late summer, fall or winter pasture feeds. This has been attributed to better digestibility of young grasses and plants, with faster digestive pass through and shorter fermentation, and thus less production of methane. However, the chemical makeup of the grasses and plants vary depending on maturity, and it is possible that spring time young grasses and legumes (alfalfa) and other plants contain components that alter rumen microbial metabolism, and affect methane emissions by other pathways in addition to greater digestible forage. For example, the leaves and stems of young grasses have higher levels of malate and citrate acid, 6 MBOA, and fatty acids. Certain chemicals with methane inhibitory activity have been added into the diet of the animal or tested in in vitro rumen fermentation simulators and have met with some success. These include adding the following ingredients to feed concentrates: antibiotics (monesin, penicillin, others); hydroxymethylglutaryl-SCoA (HMG-CoA) reductase inhibitors; plant extracts, including garlic oil, yucca extract, tannins, saponins; organic acids, including malate and fumarate; and fatty acids, including linseed oil and sunflower oil. Fatty acid supplementation may inhibit protozoa (defaunation, reducing the number of protozoa, thereby reducing the number of methanogens). Additionally, vaccines that target rumen methanogenic bacteria are being tested, and various methods of defaunation including vaccines against rumen protozoa have been studied as methods of methane reduction (Boadi et al, 2004).

Ionophores, such as monesin, inhibit the growth of gram positive bacteria that produce hydrogen, thereby reducing the amount of hydrogen available for the methanogenic bacteria. There is some evidence that the effects of antibiotic treatment are temporary, and dosages have been related to animal performance (weight gain and milk production), but not reduction of methane emissions or increases in propionate. Additionally, antibiotic use in livestock for human consumption has been banned in Europe and is under fire in the United States and other parts of the world. Hydroxymethylglutaryl-SCoA (HMG-CoA) Reductase inhibitors show promise, but will likely require new drug approval by the FDA, and therefore will be slow to market and costly (Beauchemin et al., 2008).

Organic acids have been more extensively studied, both in vitro and in vivo studies have shown positive effects regarding methane reduction, positive weight gain and avoidance of lactic acid problems in the rumen. However the precise optimal concentration and delivery of the organic acid are not known, and at least for malate, the price of the acid is high and thus cost prohibitive to be considered as a single agent supplement (Beauchemin et al., 2008).

Saponins are naturally occurring secondary compounds present in many plants and of high molecular weight glycosides in which sugars are linked to a triterpene or steroidal aglycone moiety. Saponins or saponin containing forage are toxic to rumen protozoa which could be beneficial for improved ruminant productivity depending on the diets and the saponins involved. Ciliate protozoa are primarily responsible for the substantial turnover of bacterial protein. As a consequence nitrogen retention is improved by defaunation. It is generally agreed that removing or suppressing protozoa would result in increased ruminant performance, particularly on low-protein diet. It seems that effect of saponins is diet dependant. Therefore, there is need to identify the saponins that would be beneficial for ruminal manipulation and hence ruminant production (Beauchemin et al., 2008).

Tannins are the polyphenolic polymers distributed widely in many plants. A number of forages contain condensed tannins which are beneficial for the rumen fermentation when they are present in moderate quantity (4% to 6% of the total) in the diets. However, high dietary concentrations (6%-12% DM) may depress voluntary feed intake, digestive efficiency and animal productivity. Animals fed tannin rich forage in moderate quantity demonstrate better overall performances such as higher growth rates, improved reproductive performance, wool production and higher milk yield with increased milk protein in addition to reduced gastrointestinal parasites burden. One of the reasons for these effects could be possibly due to increased metabolizable protein supply, from the protein binding action of condensed tannins in the rumen (neutral pH range) when animals are fed a diet with highly degradable protein. The tannin-protein complexes are released in gastric and gut pH environments. Additionally, tannins have decrease methane inhibition. Many types of forage known to contain condensed tannins have been shown to decrease methane production both in vivo and vitro (Beauchemin et al., 2008).

Dietary supplementation of yeast cultures has been in practice for many years, and has been shown to improve milk production in cattle and growth rates in cattle and sheep. However, yeast strains have not been selected on the basis of their ability to specifically reduce methane production or increase propionate. Identification of a novel species of yeast that has these characteristics for promoting healthy rumen fermentation would be an advance in the field (Beauchemin et al., 2008).

While some antibiotics and other chemicals, and some plant components have shown inhibitory activity regarding rumen methanogenesis, many have toxic or temporary effects when deployed in vivo. Thus there is a need for a novel effect approach that will inhibit methane production in ruminant animals.

### SUMMARY OF THE INVENTION

A primary object of the present invention is to provide novel chemical compositions and resultant formulations derived, isolated and/or extracted from monocotyledonous and dicotyledonous plants or by chemical synthesis, and methods for using said compositions to reduce enteric methane emissions from animals, and improve animal performance (weight gain/maintenance, milk production, meat quality/leanness, overall health). The current invention is the composition, method and formulation of animal feed supplements components that singly, and in combination, enhance feed efficiency and reduce enteric methane emissions. Plant products, including grasses and other plants grown and processed to yield higher animal production efficiency and methane inhibition when fed to animals will be utilized.

The current invention is the method and formulation of animal feed supplements that singly, and particularly in combined formulations, enhance feed efficiency and reduce enteric methane emissions. Plant products, including grasses and other plants grown and processed to yield higher animal production efficiency and methane inhibition when fed to animals will be utilized.

It is a still further object of the invention to provide novel methods for growing harvesting monocotyledonous and dicotyledonous plants which results in a desired levels/yield of organic acids, fatty acids, phenolic compounds, tannins, saponins or other components with antimicrobial or antiprotozoa activity. Grasses, including zea mays, and legumes (including alfalfa and sanfoin) are harvested as immature plants (a phase of plant status where the plant leaves are highly digestible, and contain natural occurring substances that have antimicrobial and anti-protozoa activity, substantial levels of organic acids including malic acid, high levels of phenolic compounds and high levels of fatty acids and tannic acids). While plants for use as feed for animals are generally harvested at a mature state to maximize yield, the levels of desired nutrients for the purpose of decreasing methane emissions, increasing propionate and enhancing animal performance occur at an immature phase. Plants produce a variety of secondary metabolites as immature plants as protection against microbial and insect attack. Naturally occurring antimicrobial elements within feed substances may be of benefit in efforts to alter rumen microbiology and reduce enteric methane production.

Camelina sativa cakes, before or following extraction of camelina oil, is prepared as a feed supplement intended to deliver to the rumen a concentration of unsaturated fatty acids, especially C-18 fatty acids (particularly alpha-linolenic) in addition to protein and other nutrients. Preferably, the camelina may be harvested at a stage before the flowering period, a time of optimal nutritional value, highest protein level, less lignin content and good levels of omega-three fatty acids. Alternatively, the mature plant may be utilized, and the seed cakes used for a feed supplement following oil extraction. The process for cultivation, timing of harvest and preparation will be optimized to alter rumen fermentation, enhance feed efficiency and methane emission reduction.

It is also an object of the present invention to provide novel chemical compositions and resultant formulations derived, isolated and/or extracted from monocotyledonous and dicotyledonous plants or by chemical synthesis, and methods for using said compositions for reducing levels of enteric methane produced by rumen methanogens.

Additionally, it is an object of the present invention to provide novel chemical compositions and resultant formulations derived, isolated and/or extracted from monocotyledonous and dicotyledonous plants or by chemical synthesis, and methods for using said compositions for increasing the production of enteric propionate.

It is a further object of the present invention to provide novel chemical compositions derived, isolated and/or extracted from monocotyledonous plants and dicotyledonous or by chemical synthesis, and methods for using said compositions and resultant formulations to reduce numbers of hydrogen producing gram positive bacteria and methanogenic bacteria in the rumen.

It is a still further object of the present invention to provide novel chemical compositions and resultant formulations derived, isolated and/or extracted from monocotyledonous plants and dicotyledonous or by chemical synthesis, and methods for using said compositions to decrease numbers of ruminal protozoa.

One presently preferred embodiment of an effective method of the present invention comprises the ingestion by animals of the novel compounds of the present invention while still contained in dried leaves from monocotyledonous plants with such compounds or taken as purified and/or synthesized preparations. It appears, based on the findings of the inventors, that the compounds of the present invention have antimicrobial activity against gram positive bacteria.

A source of the compounds of the present invention for use in animals to reduce enteric methane production and improve animal performance may be found in monocotyledonous and dicotyledonous plants in their early growth stages. The harvest and processing methodology is unique and optimized for the desired components of the plant material relative to the invention. To obtain these compounds at desired concentrations from such plants, the harvesting of these plants at an early life history stage and drying using explicit parameters, as well as specific analytical criteria to ascertain suitability, are employed. However, it is also possible to get the compounds of the present invention at concentrations suitable for use by pressing the liquid from the leaves and stems of fresh monocotyledonous and dicotyledonous plants, and using the liquid and/or remaining plant materials, optimized using specific analytical criteria. Furthermore, the compounds of the present invention may also be obtained through chemical synthesis.

The current invention is intended to deliver the fatty acids contained in camelina sativa plants to the rumen, in a concentration that reduces rumen protozoa and methogen bacteria activity and numbers, and inhibits methane production, while not negatively affecting digestion. Generally this will include total levels of fatty acids to be not greater than 5.0% of dry matter intact (DMI). The primary fatty acid contained in the camelina sativa plant material, seed cake or oil will be alpha-linolenic acid, ranging from 400 g/kg to >550 g/kg of the total fatty acid content. The polyunsaturated fatty acids comprise >65% of the total fatty acids in the plant. The camelina plants may be harvested as young, immature plants, or fully seeded plants and utilized as seed cake supplements after oil extraction.

Various species of yeast and other microorganisms have negative effects on methane production and/or increase propionate in the rumen. Identification of species with these characteristics, and optimization of number, viability and delivery, will lead to development of a feed additive that promotes feed efficiency and animal performance while reducing methane emissions.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 illustrates an embodiment of the antibacterial activity of the grass preparations against Staph aureus 7742;

FIG. 2 illustrates an embodiment of the antibacterial activity of the grass preparations against Staph aureus ATCC 25923;

FIG. 3 illustrates an embodiment of the antibacterial activity of the grass preparations against Streptococcus bovis ATCC 49147;

FIG. 4 illustrates an embodiment of the antibacterial activity of the grass preparations against Escherichia coli ATCC 25922;

FIG. 5 illustrates an embodiment of the antibacterial activity of the grass preparations against Escherichia coli clinical isolate 7747;

FIG. 6 illustrates an embodiment of the antibacterial activity of the grass preparations against Candida albicans ATCC 10251;

FIG. 7a illustrates an embodiment of a testing model for the measurement of enteric methane production in supplemented sheep showing the kinetics of daytime methane emissions; and

FIG. 7b illustrates an embodiment of a testing model for the measurement of enteric methane production in supplemented sheep showing the total daytime methane emissions.

### DESCRIPTION OF THE PREFERRED EMBODIMENT

The plants and grasses, are grown to a specific maturity stage, generally immature, 2 to 20 weeks post planting, and harvested. The timing of the harvest is optimized to the higher levels of organic acids, fatty acids, tannic acids and phenolic compounds, including cinnamic acid and 6-methoxy-2,3-benzoxazolinone. Levels of organic acids, malate, will be in the range of 5% to 8% of dry matter. Levels of total fatty acids will be in the range of 25 mg g⁻1 to 75 mg g⁻1 of dry matter. The leaves and stems of the plants may be dried and made into powder or further processed into pellets. Drying conditions of the recently harvested plant material will be accomplished by using forced hot air dryers, with temperatures between 30° C. to 60° C. for 30 minutes to 24 hours to achieve desiccation of the plant cells and cessation of metabolic activity of plant cells and plant associated microorganisms. The material may be sprayed with propionic acid as a preservative. The material is then ground into a powder. The powder may be further processed into pellets by mixing the powder with a binder, such as molasses or glycerol, and pressed into pellets ranging in size from 3 mm to 3 cm. Using glycerol is a preferred embodiment, due to the positive effects on improvement of pellet quality, reduction of dust and enhancement of propionate production. Glycerol may be directly fed to animals, or may be derived from hydrolysis of dietary triglyceride by rumen bacteria. By either source, the glycerol is fermented principally into propionic acid. Concentrations of glycerol to be included in the formulation will be in the range of 5 gms/kg to 100 gms/kg.

Alternatively, the freshly harvested plant materials may be subjected to pressing, resulting in a liquid portion and remaining plant material portion, and it may be further processed for preservation and prevention of degradation of specific contents of the material and avoidance of microbial growth. The feed supplement may be treated with ozone to sterilize and preserve the material. The ozone may be applied immediately after harvest and at other stages of processing to kill living cells and microbes and prevent degradation of the materials. This may be accomplished by bubbling ozone into the liquid obtained from the plants, to effectively kill microbes and cease all metabolic activity, decontaminating the liquid prior to storage. Ozone exposure may also be applied to dry material, or during the drying process described above. The ozone exposure may be at a concentration of 1-100 ppm for periods of time ranging from 1 minute to 4 hours. Alternatively, the liquid may be filtered to remove contaminants/microorganisms, or pasturerized, using commonly known methods, temperatures and times, to decontaminate liquids. The remaining plant material may be air dried and ground into powder. The pH of the material/liquid may be manipulated to inhibit enzymatic activity to prevent degradation of the material, with a preferred pH below 6.0 to inhibit proteases and other enzymes.

The powder, pellet or liquid from the grasses and plants may have additional materials added, including organic acids (malate, fumarate), to increase the levels to desired concentrations. The addition of malate or fumarate to the supplement formulation to enhance the availability of these organic acids in the animal's diet, and serve as a substrate for the production of propionate. The additive organic acids, specifically malate, will be in the range of 0.5 gm to 400 gms per dose. In addition to adding glycerol as a binder for the pelleted material, glycerol may also be added to the liquid as a precurser enrichment for propionate production. Condensed tannins may also be a component of the final formulation, deriving from natural products (particularly sanfoin) not to exceed a total of 5% tannin to protect proteins and inhibit methane emission.

This inventive approach utilizes several components, each with effects on feed efficiency and methane production, and potential additive or synergistic effects when combined into a feed supplement strategy. For example, if one component of the formulation has antimicrobial activity against gram+bacteria (reducing available hydrogen for use by methanogens), or has antimicrobial activity directly against methanogens or protozoa (thereby reducing the number of methanogens), then adding malate may have an additive or synergistic effect towards the goal of increasing propionate by providing substrate. By combining components with methane-reducing activity, lower concentrations may be used thereby decreasing the possibility of undesirable and possibly toxic effects. For example a direct toxic effect of unsaturated fatty acids on methanogens has also been reported for mixed rumen bacteria in vitro. Fatty acids are especially toxic to Gram-positive bacteria, whereas Gram-negative bacteria are less sensitive to fatty acids at the same concentration. One possible embodiment would be to formulate a supplement containing a certain concentration of immature grass leaves that have a given antimicrobial activity level, along with fatty acids in the form of camelina sativa harvested plant parts (or camelina oil), or flax cake or flax oil, optimized to a given amount of unsaturated fatty acids (a concentration that is below that which interferes with rumen digestion and fermentation), along with malate to provide substrate for propionate production. Additionally, camelina is known to have a high protein content as an immature plant (220 g/kg DM in the vegetative phase, vs 92 g/kg DM in the ripe seed-pod stage). Harvesting camelina at the vegetative phase, with a lower but still significant omega-3 fatty acid content, and a lower lignin content (greater digestibility) would provide a feed with anti-methane activity (fatty acids), at a level that would not affect digestion, while supplementing the animal's diet with extra protein. Adding tannins to this formulation would also have anti-methane effect, while providing protection for the proteins to move from the rumen to be utilized by the animal.

The invention consists of a method for obtaining compounds of the invention at concentrations suitable for feed supplements from plants grown to an immature stage of growth. “Concentrations suitable as feed supplement” means that compounds of the invention in amounts of dried plant material or liquid obtained from fresh plants that make up a daily or twice daily dose of an effective concentration of the compounds of the invention. The concentration may be optimized as to level of organic acid, tannic acid, minimally effective antimicrobial activity, fatty acid level (including specific fatty acids; omega 3 fatty acids; alpha linolenic acid), or other components of the plant shown to have antimicrobial activity such as 6 MBOA, enteric methane reduction activity or enhancement of rumen propionate levels. Said dosage may include either the novel compound(s) as it (they) naturally occur or synthetically, or a combination of both natural and synthetic novel compounds of the present invention.

Specific planting, harvesting and processing conditions are utilized in the invention. The plants are planted in a manner to maximize yield of specific components of the plants, such as organic acids, phenolic compounds, fatty acids, and tannins and saponins, methods that may include stressing of the plants due to crowding or water deprivation. The plants are harvested at a time optimal for obtaining the desired levels of compounds that have anti-methane activity and enhanced feed efficiency, generally as immature plants, within the first half of development to maturity (2-20 weeks post planting), or during the vegetative state, before flowering.

Some of the compounds with the desired activities are found in monocotyledonous flowering plants. Preferred selections include grasses that are appropriate as feed for animals, particularly ruminants, including corn, wheat, barley, oats, rice and rye, gama grass, sorghum, sugarcane, timothy, bent grass, bluegrass, orchard grass, fescue, wild grasses, bromegrass, millet, bamboo, and other barley-like grasses. Other plants may also contain compounds with desired activities, including dicotyledonous plants, such as legumes, including alfalfa and sanfoin (tannic acid), and camelina or flax (fatty acids).

The compounds may be administered as ground/powdered leaves and stems of plants in which they naturally occur, or in pelleted form (powder combined with binder, such as molasses or glycerol). The compounds may also be administered as a liquid, ingested directly or sprayed upon feed, or added to plant materials subsequently pelleted. Alternatively the compounds may be administered as purified or chemically synthesized compounds in an acceptable carrier. The compounds of the present invention are intended to be administered orally in the form of powder or pelleted feed supplements, suspensions, solutions, pastes, gels, boluses or other suitable means for ingestion. Other compounds may be added to prolong to sustain levels of desired components within the rumen to enhance anti-methane activity or to increase propionate levels or otherwise assist in achieving the desired effects.

Unless otherwise defined, the technical, scientific and medical terminology used herein has the same meaning as understood by those informed of the art to which this invention belongs. However, for the purposes of establishing support for various terms that are used in the present application, the following technical comments, definitions and review are provided for reference.

“Global warming” is the increase in the average temperature of the Earth's near-surface air and oceans in recent decades and its projected continuation.
“Greenhouse gases” are components of the atmosphere that contribute to the greenhouse effect. Without the greenhouse effect the Earth would be uninhabitable;^{[1]} in its absence, the mean temperature of the earth would be about 19° C. (2° F.) rather than the present mean temperature of about 15° C. (59° F.). Greenhouse gases include in the order of relative abundance water vapour, carbon dioxide, methane, nitrous oxide, and ozone.
“Carbon dioxide” (chemical formula: CO₂) is a chemical compound composed of two oxygen atoms covalently bonded to a single carbon atom. It is a gas at standard temperature and pressure and exists in Earth's atmosphere in this state. Carbon dioxide is an important greenhouse gas because it transmits visible light but absorbs strongly in the infrared.
“Methane” is a chemical compound with the molecular formula CH₄. Methane is a relatively potent greenhouse gas with a high global warming potential (i.e., warming effect compared to carbon dioxide).
The “rumen” forms the larger part of the reticulorumen, which is the first chamber in the alimentary canal of ruminant animals. It serves as the primary site for microbial fermentation of ingested feed, enabling ruminants to eat tough plants and grains that monogastric animals cannot digest.
“Methanogens” are archaea bacteria that produce methane as a metabolic byproduct in anoxic conditions such as the rumen.
“Ozone” (O₃) is a triatomic molecule, consisting of three oxygen atoms. It is an allotrope of oxygen that is much less stable than the diatomic O₂. It can be used for bleaching substances and for killing microorganisms in air, on surfaces, and in liquids.
“Defaunation” refers to the reduction or elimination of protozoa from the rumen of animals.
A “Lipid or fatty acid” is a carboxylic acid often with a long unbranched aliphatic tail (chain), which is either saturated or unsaturated.

Lipids: fatty acids

| | |
|---|---|
| Saturated | Butyric - Hexanoic - Caprylic - Decanoic - Lauric - |
| | Myristic - Palmitic - Stearic - Arachidic - Behenic - |
| | Lignoceric |
| Omega-3 fatty acid | Alpha-linolenic - Stearidonic acid - |
| | Eicosapentaenoic acid - Docosahexaenoic acid |
| Omega-6 fatty acid | Linoleic - Gamma-Linolenic acid - Dihomo-gamma- |
| | linolenic acid - Arachidonic |
| Omega-9 fatty acid | Oleic - Erucic |

“Malic acid” is a tart-tasting organic dicarboxylic acid that plays a role in many sour or tart foods. The salts and esters of malic acid are known as malates. Malate anion is an intermediate in the citric acid cycle along with fumarate.
“Fumaric acid” is the chemical compound with the formula HO₂CCH═CHCO₂H. This colorless crystalline compound is one of two isomeric unsaturated dicarboxylic acids, the other being maleic acid wherein the carboxylic acid groups are cis. The salts and esters of fumaric acid are known as fumarates.
A “propionate” compound is a salt or ester of propionic acid.
“Enteric fermentation” is fermentation that takes place in the digestive systems of ruminant animals. Enteric fermentation occurs when methane (CH₄) is produced in the rumen as microbial fermentation takes place. Over 200 species of microorganisms are present in the rumen, although only about 10% of these play an important role in digestion.
“Ruminants” refers to any hoofed animal of the suborder Ruminantia and the order Artiodactyla, characteristically digesting its food in two steps. Ruminants include cattle, sheep, goats, llamas, giraffes, bisons, buffalo, deer, elk, wildebeest, antelope, pronghorn, alpacas and yaks. The following examples will illustrate the practice of the present invention in further detail. It will be readily understood by those skilled in the art that the following methods, formulations, and compositions of novel compounds of the present invention, as generally described and illustrated in the Example herein, are to be viewed as exemplary of the principles of the present invention, and not as restrictive to a particular structure or process for implementing those principles. Thus, the following more detailed description of the presently preferred embodiments of the methods, techniques, formulations and compositions of the present invention, as represented in Examples 1-7, is not intended to limit the scope of the invention, as claimed, but is merely representative of presently preferred embodiments of the invention.

### EXAMPLES

### Examples 1-6

Samples of dried corn leaves, liquid from fresh corn leaves and liquid from fresh gama grass were obtained, the preparations were all grown and harvested in a manner described in the current invention. The grasses were harvested as immature plants, the liquid was stored at 4 C and the powder processed by air drying and grinding. Two preparations of immature grasses (zea mays; gama grass; liquid) containing compounds of the present invention were tested for antimicrobial activity in an agar well diffusion assay measuring Zone of Inhibition. “Grass 1” was a liquid component of a preparation of zea mays; “Grass 2” was a liquid component of gama grass.

The agar well diffusion method for determining the antimicrobial susceptibility testing of differing plant extracts was utilized along with the Kirby-Bauer disc diffusion method. The Kirby-Bauer method is employed for quality control purposes and to compare the zone of inhibition size of a standard antimicrobial agent(s) to the test extract(s). The agar well diffusion method is similar to the Kirby-Bauer method recommended by the NCCLS with the exception of 6 mm wells being made into the standard 150 mm Mueller Hinton Agar plate by sterile technique vs. inoculated 6 mm discs being placed onto the agar surface. Six organisms were tested; gram positive (staph aureus 1-ATCC 25923; staph aureus 2-clinical isolate 7742; streptococcus bovis-ATCC 49147); gram negative (e coli 1—ATCC 25922; e coli 2—clinical isolate 7747) and a fungi (candida albicans—ATCC 10251). A standard antimicrobial inoculated on a 6 mm disk was used as a positive control. (Gentamicin Susceptibility Disks, 10 μg). For initial growth of the organisms, at least three to five well isolated colonies of the test organism were selected from the SBA agar plate by touching the tops of each colony. The growths were transferred to a tube of 3-5 ml Tryptic Soy Broth. The broth culture was incubated at 35° C. until it achieved or exceeded the turbidity of the 0.5 McFarland standard (usually 2-6 hours). The turbidity of the actively growing culture was adjusted with sterile saline or broth to obtain a turbidity of the 0.5 McFarland standard. This resulted in a suspension containing approximately 1 to 2×10⁸ CFU/ml. Using sterile technique equally spaced wells were “punch out” in the Mueller-Hinton agar using a 6-mm biopsy punch. The surface of a Müeller-Hinton agar plate was inoculated, after test wells have been made, by streaking the swab over the entire agar surface. The plates were then inverted and incubated at 35° C. in an aerobic incubator for 18-24 hours. The antimicrobial activity of the plant extracts was indicated by clear zones of growth around the test wells. The tests were run twice (Prep 1 and Prep 2).

### Example 1

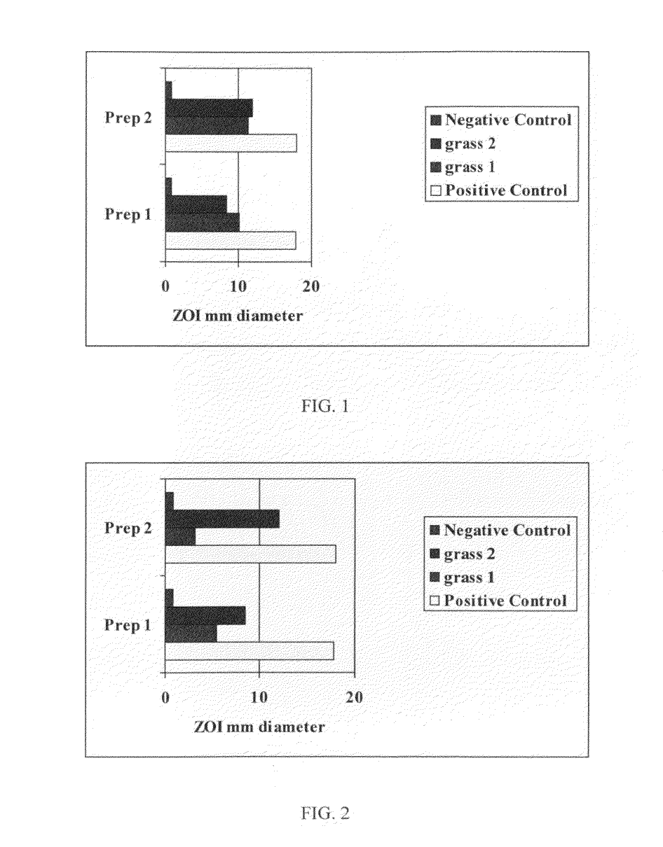

An embodiment of the antibacterial activity of the grass preparations against Staph aureus is illustrated in FIG. 1. As shown, both grass preparations had significant activity against the clinical isolate grain positive Staph aureus 7742, in both test runs.

### Example 2

An embodiment of the antibacterial activity of the grass preparations against Staph aureus ATCC 25923 is illustrated in FIG. 2. As shown, both grass preparations had activity against the ATCC 25923 gram positive Staph Aureus, in both test runs. The gama grass preparation (grass 2) demonstrated a stronger effect against this organism, compared with the zea mays (grass 1) preparation.

### Example 3

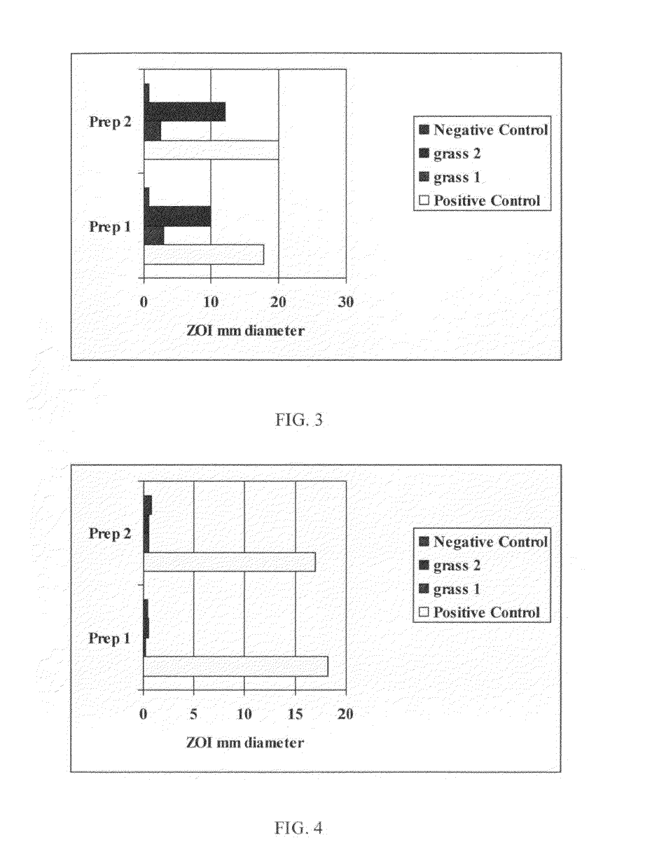

An embodiment of the antibacterial activity of the grass preparations against Streptococcus bovis ATCC 49147 is illustrated in FIG. 3. As shown, both grass preparations had activity against the Streptococcus bovis ATCC 49147 gram positive, in both test runs. However, the gamagrass preparation (grass 2) demonstrated a stronger effect against this organism, compared with the zea mays (grass 1) preparation.

### Example 4

An embodiment of the antibacterial activity of the grass preparations against Escherichia coli ATCC 25922 is illustrated in FIG. 4. As shown, neither grass preparation had activity against the E. coli ATCC 25922 gram negative, a finding seen in both test runs.

### Example 5

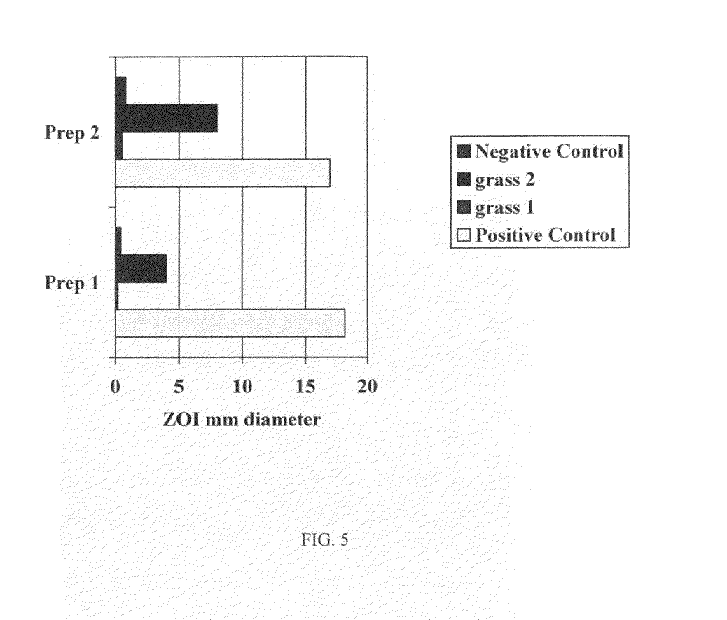

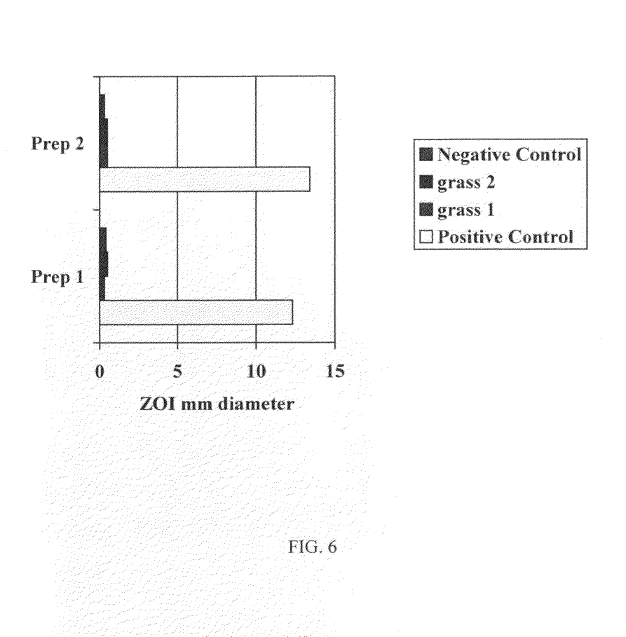

An embodiment of the antibacterial activity of the grass preparations against Escherichia coli clinical isolate 7747 is illustrated in FIG. 5. As shown, the zea mays preparation (grass 1) showed no activity against the gram negative clinical isolate 7747 in either test. However, the gama grass preparation (grass 2) showed weak activity in both tests.

### Example 6

An embodiment of the antibacterial activity of the grass preparations against Candida albicans ATCC 10251 is illustrated in FIG. 6. As shown, the grass preparations showed no activity against the Candida albicans ATCC 10251.

### Example 7

A testing model for measurement of enteric methane production in sheep was utilized. A pelleted feed supplement was prepared using immature grass and plants optimized for phenol, fatty acid, and organic acid content. Four 18 month old Rambouillet ewe sheep were feed control and supplemented diets, standardized as to calories and nutrients, and placed in a testing room for serial methane measurements of methane in the air using a portable gas chromatograph. Normal background measures were 0-4.0 ppm, while measurements of the air with two sheep in the room for one or more hours have ranged from 100-1500 ppm, dependent upon the feed and supplement formulation being administered to the animals, and on the time of day and time post feeding initiation.

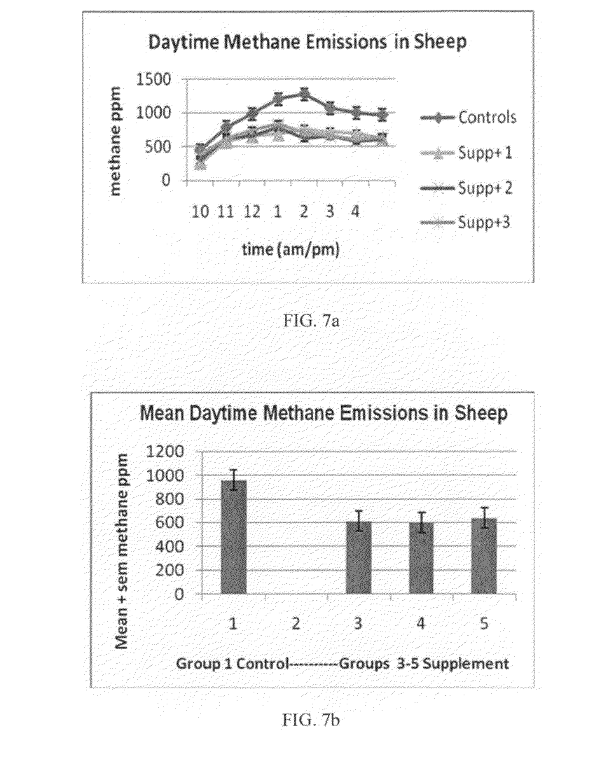

Referring now to FIG. 7a, an embodiment of a testing model for the measurement of enteric methane production in supplemented sheep is shown. As demonstrated, FIG. 7a illustrates the kinetics of daytime methane emissions which resulted in significant reductions in methane emissions in sheep feed the inventive supplement. Further, as illustrated in FIG. 7b, the total daytime methane emissions were lower in supplemented sheep compared with controls.

What is claimed and desired to be secured by United States Letters Patent is:

1. A method for enhancing feed efficiency and reducing enteric methane production in livestock, comprising a novel formulation of natural plants and plant extracts and chemicals, including propionatic acid and glycerol, that when feed to ruminants result in decreased enteric methane production and improved feed efficiency.

2. A feed composition as defined in claim 1, comprised of components that singly, and in combination, enhance feed efficiency and reduce enteric methane emissions.

3. A composition according to claim 2, consisting of an animal feed comprised of a novel preparation of early stage harvested monocotyledonous and dicotyledonous plants, harvested at an immature life stage yielding high levels of organic acids, fatty acids, phenolic compounds, tannins, saponins and other components with antimicrobial or antiprotozoa activity.

4. The animal feed composition in claim 2, consisting of monocotyledonous and dicotyledonous plants that are grown to a specific maturity stage, generally immature, 2 to 20 weeks post planting, and harvested. The timing of the harvest is optimized to the higher levels of organic acids, fatty acids, tannic acids and phenolic compounds, including cinnamic acid and 6-methoxy-2,3-benzoxazolinone and indolamines. Levels of organic acids, malate, will be in the range of 5% to 8% of dry matter. Levels of total fatty acids will be in the range of 25 mg g⁻1 to 75 mg g⁻1 of dry matter. Levels of total phenolic compounds will be in the 5 ug to 500 ug/g dry matter. A feed composition and process as defined in claim 2, a component comprising immature grasses, including corn, gamagrasses, wheat, barley, barley-like grasses, rye, oats, rice, sorghum, millet, bamboo, and wild grasses harvested at an immature stage.

5. A feed composition and process as defined in claim 2, a component comprising legumes, including but not limited to alfalfa and sainfoin, harvested at an immature stage.

6. A feed composition and process as defined in claim 2, a component comprising camelina, flax or canola plants, harvested at an imm^{a}ture stage o^{r} a mature stage, for fatty acids.

7. A process as defined in claim 3, wherein harvested plants are dried at a temperature in the range of between about 30 degree. C. and about 60 degree for 30 minutes to 24 hours to achieve desiccation of the plant cells and cessation of metabolic activity of plant cells and plant associated microorganisms.

8. A process as defined in claim 3, wherein harvested plant material is sprayed with proprionic acid as a preservative.

9. The process as defined in claim 3, wherein the harvested plant material is ground into a powder, and further processed into pellets by mixing the powder with a binder, such as molasses or glycerol, and pressed into pellets ranging in size from 3 mm to 3 cm. Using glycerol is a preferred embodiment, due to the positive effects on improvement of pellet quality, reduction of dust and enhancement of propionate production. Concentrations of glycerol to be included in the formulation will be in the range of 5 to 100 gms/kg.

10. The process as defined in claim 3, wherein the freshly harvested plant materials may be subjected to pressing, resulting in a liquid portion and remaining plant material portion, and it may be further processed for preservation and prevention of degradation of specific contents of the material and avoidance of microbial growth. The feed supplement may be treated with ozone to sterilize and preserve the material.

11. A process as defined in claim 1, wherein said administered feed supplement comprises a daily dosage individualized to body weight of between about 0.1% and 50% of the total daily ration of feed.

12. A process as defined in claim 1, wherein said animal is selected from the group consisting of ruminants, including cattle, sheep, goats, llamas, giraffes, bisons, buffalo, deer, elk, wildebeest, antelope, pronghorn, alpacas and yaks. A process as defined in claim 1, wherein said chemical composition is administered in a manner selected from the group consisting of: (1) orally, in the form of pellets, tablets, powder, capsules, suspensions, solutions, free choice block and other means suitable for ingestion.
